(19) United States
(12) Patent Application Publication
(10) Pub. No.: US 2007/0109484 A1
(43) Pub. Date: May 17, 2007

(54) Drive element mount display

(75) Inventors: Shunichi Murahashi, Nabari-shi (JP); Hiroshi Nishioka, Yamatokoriyama-shi (JP); Kazuyuki Horinouchi, Iga-shi (JP)

Correspondence Address: HARNESS, DICKEY & PIERCE, P.L.C., P.O. BOX 8910, RESTON, VA, 20195, US

(73) Assignee: Sharp Kabushiki Kaisha

(21) Appl. No.: 11/594,931

(22) Filed: Nov. 9, 2006

(30) Foreign Application Priority Data
Nov. 15, 2005 (JP) 2005-330773

(51) Int. Cl. G02F 1/1345

(52) U.S. Cl. 349/149

(57) ABSTRACT

A drive element mount display is provided which achieves fine output pad pitches for a display panel driver without reducing the pitches of the connection terminals of display panel wires which connect to the display panel driver. In a liquid crystal driver mount display 1, liquid crystal display means 2 connects to a liquid crystal driver 3 via a driver socket 4a. On the driver socket 4a, the connnection terminals for the liquid crystal display means 2 have larger pitches than the connection terminals for the liquid crystal driver 3. The design eliminates the need to secure a large wiring region on a glass substrate 10, even when the liquid crystal driver 3 is mounted to the glass substrate 10 of the liquid crystal display means 2.

This nonprovisional application claims priority under 35 U.S.C. § 119(a) on Patent Application No. 2005-330773 filed in Japan on Nov. 15, 2005, the entire contents of which are hereby incorporated by reference.

### FIELD OF THE INVENTION

The present invention relates to a drive element mount display. More specifically, the invention relates to a display fabricated on a glass substrate which accommodates on its frame a liquid crystal driver with numerous fine-pitch output terminals without having to match the driver-connecting terminals of the substrate with the fine pitch and which still allows reductions in frame area.

### BACKGROUND OF THE INVENTION

Various schemes are used to mount liquid crystal drivers. TCP (Tape Carrier Package) and SOF (System On Film; also called Chip On Film or COF) are a few known examples. These schemes employ foldable packages to fulfill the need to mount components along the glass edge of the liquid crystal panel and to reduce the size of the panel frame.

FIGS. 12 and 13 show a TCP structure for IC chip packaging. FIG. 12 is a partially transparent top view of the TCP structure. FIG. 13 is a cross-sectional view of the TCP structure shown in FIG. 12 taken along line B-B′. The TCP structure 120 shown in FIGS. 12 and 13 has slits 114 and a hole 115 called a device hole in a film base material 113. Copper wires 111, 112 are disposed on the film base material 113. On the wires 111, 112 are there provided a solder resist 116. The IC chip 101 sits inside the device hole 115. The bumps 110 on the surface of the IC chip 101 connect to the wires 111, 112.

FIGS. 14 and 15 show a SOF structure for IC chip packaging. FIG. 14 is a top view of the SOF structure. FIG. 15 is a cross-sectional view of the SOF structure shown in FIG. 14 taken along line B-B′. The SOF structure 130 has copper wires 111, 112 formed on a film base material 113. A solder resist 116 is disposed on the copper wires 111, 112. The copper wires 111, 112 and the IC chip 101 are connected via bumps 110 of the IC chip 101. As shown in FIG. 15, an underfill material 117 is disposed as a filling which protects the IC chip 101, etc. from the environment.

A recently popular scheme is COG (Chip On Glass) in which a liquid crystal driver is mounted directly on a glass substrate which serves as a liquid crystal panel. COG packaging is used, for example, in a configuration described in Japanese Unexamined Patent Publication 1-128534/1989 (Tokukaihei 1-128534; published May 22, 1989).

A liquid crystal driver contains a growing number of drive circuits. Some recent mass-manufacture products are equipped with more than 500 outputs.

The IC chip, as it gets smaller, exhibits higher mass manufacturing efficiency and lower cost per chip. To exploit these benefits by scaling down the chip, pad pitches in a driver with a large number of outputs like those described above should be narrowed.

However, fine output wire pitches in liquid crystal drivers raise the following problems. Signal wires of a liquid crystal panel (data and gate lines leading to liquid crystal pixels) near pixels have pitches close to those for the pixels, that is, naturally wider than those for the liquid crystal driver outputs. In addition, pixel pitches do not change with narrowing liquid crystal driver pitches. As the liquid crystal driver has diminishing output wire pitches, the liquid crystal driver mounted on the glass substrate of the liquid crystal panel requires a larger area of the glass substrate in which to collect signal wires. This could be an obstacle in narrowing down the frame area. FIG. 16 shows how the output pitch of the liquid crystal driver can affect a wiring region of the liquid crystal panel.

(a) in FIG. 16 shows a wiring region 202a stretching between a driver 200 and liquid crystal panel data lines 201 when the liquid crystal data driver 200 has output pitches of A μm. (b) in FIG. 16 shows a wiring region 202b stretching between a driver 200 and liquid crystal panel data lines 201 when the liquid crystal data driver 200 has output pitches of 2×A μm. A comparison of (a) and (b) would show that the wiring region for the driver outputs and liquid crystal panel data lines is substantially halved. As demonstrated here, a narrow liquid crystal driver pad pitch leads to a greater wiring region between the liquid crystal driver and the liquid crystal panel data lines, which in turn adds to the frame area.

### SUMMARY OF THE INVENTION

In view of these problems, it is an objective of the present invention to provide a drive element mount display in which the pitches of the output pads of a display panel driver are narrowed down whereas the pitches of the wire terminals of the display panel connecting to the display panel driver are not narrowed down.

A drive element mount display in accordance with the present invention, to solve the aforementioned problems, includes: display means with signal wires and a transparent substrate; and a drive element applying voltages to the signal wires to drive the display means, and is characterized in that the drive element includes: a driver with an integrated circuit and a group of input/output terminals; and a semiconductor substrate, the substrate including: a group of driver-end connection terminals adapted to connect to the group of input/output terminals; a group of display means-end connection terminals adapted to connect to a group of terminals of the signal wires; and wires connecting the group of driver-end connection terminals to the group of display means-end connection terminals; the group of driver-end connection terminals is adapted to have pitches which match pitches of the group of input/output terminals; and the group of display means-end connection terminals has pitches not narrower than a minimum pitch of the group of driver-end connection terminals. Specifically, it is preferable if the drive element is disposed on the transparent substrate of the display means. It is also preferable if the group of display means-end connection terminals, the group of driver-end connection terminals, and the wires are disposed on one surface of the semiconductor substrate.

According to the arrangement, for example, even when a liquid crystal driver with a large number of outputs of fine pitches is mounted, there is no need to match the pitches of the terminals of the signal wires of the display means to the fine pitches of the liquid crystal driver. In addition, the driver can be made with fine pitches without considering the pitches of the terminals of the signal wires of the display means. The arrangement therefore limits increases of wiring regions where the group of input/output terminals of the driver are connected to the terminals of the signal wires of the display means even in COG mounting where the drive element is mounted onto the frame of the transparent substrate of the display means. Thus, the driver with a large number of outputs of fine pitches can be mounted onto the transparent substrate without adding to the frame area.

Specifically, since the drive element mount display in accordance with the present invention includes the semiconductor substrate, even if the driver has a large number of outputs and there terminals are formed with fine pitches, there is no need to match the terminal pitches of the signal wires of the display means to the fine pitches of the large number of outputs. In other words, on the semiconductor substrate, one of the groups of terminals, i. e. the group of driver-end connection terminals, is formed to match the pitches of the terminals of the driver, and the other group, i.e. the group of display means-end connection terminals, is formed with greater pitches than the group of driver-end connection terminals. Accordingly, the terminals of the signal wires of the display means do not need to be formed with fine pitches.

Thus, the frame area does not increase even in COG mounting a driver with a large number of outputs of fine pitches.

In addition, the inclusion of the semiconductor substrate allows the pitches of the terminals of the driver to be reduced without considering the terminal pitches of the display means so long as other conditions permit. This allows driver chip size reductions, hence cost reductions.

The drive element mount display in accordance with the present invention is preferably such that the semiconductor substrate is a silicon substrate.

The drive element mount display in accordance with the present invention is preferably such that the wires disposed on the semiconductor substrate are multilayer metal wires.

When the terminals of the display means are rearranged, the driver itself needs to be altered if the driver is directly attached to the display means. However, according to the arrangement of the present invention, the wires can be transposed on the semiconductor substrate to match the type of the display means without altering the driver. The semiconductor substrate, as mentioned above, can be manufactured by a semiconductor process. It can also be manufactured by a simpler process at lower cost than typical ICs. The invention thus offers a low cost alternative to making changes to the driver itself in accordance with changes to the display means.

The drive element mount display in accordance with the present invention is preferably such that the semiconductor substrate has circuit elements, for example, output buffer elements.

The provision of output buffer elements to the semiconductor substrate enables output driving capability to be readily altered, achieving driver cost reductions.

The drive element mount display in accordance with the present invention may be such that the semiconductor substrate has input buffer elements.

Signal inputs to the liquid crystal driver are often produced by RSDS, LVDS, or other display interface technology based on differential signals. The technology requires that a standard compliant receiver be built into the liquid crystal driver. The driver can readily operate with interfaces of different standards if the input buffers and receivers are provided on the semiconductor substrate. This reduces driver cost.

The drive element mount display in accordance with the present invention is preferably such that the semiconductor substrate has a power supply element.

To build a power supply circuit in a liquid crystal driver, the power supply circuit needs to be fabricated by a manufacturing process intended for the liquid crystal driver. It is however cost competitive to fabricate the power supply circuit by a manufacturing process intended for the power supply circuit. It is more cost saving to fabricate the semiconductor substrate by a process suitable for the power supply circuit and build the power supply in the semiconductor substrate. This reduces driver cost.

The drive element mount display in accordance with the present invention is preferably such that the semiconductor substrate has a protective element for protecting the driver from electrostatic discharge.

To prevent ESD-caused destruction, the protective element itself needs to have high voltage tolerance. This could hinder reduction in size of the protective element itself, no matter-how much the circuit is integrated into a fine structure.

The arrangement not only prevents ESD-caused destruction, but also improves on the integration of the driver by a fine process because the protective element is disposed on the semiconductor substrate. That reduces the driver chip size and cost. In contrast, the semiconductor substrate can be manufactured without using a fine process like the driver. Therefore, mounting a protective element is relatively inexpensive than mounting the protective element to the driver.

The drive element mount display in accordance with the present invention is preferably such that the semiconductor substrate has redundant buffers for, when a signal wire cuts off and is no longer capable of conveying a drive signal to a pixel of the display means, conveying the drive signal to the pixel.

If a signal wire of the display means is cut off in the middle, the cut-off line does not properly turn on. To prevent this from happening, a solution is known which saves by feeding drive signals from the other end of the cut-off line. The solution adds to the load due to the connection of signal lines and other factors, requiring drive buffers with larger-than-usual driving capability. The mounting of the large redundant buffers to the driver which is fabricated by a fine process is costly. Accordingly, in the arrangement, the redundant buffer elements are mounted to the semiconductor substrate. The structure minimizes cost increase of the semiconductor substrate manufactured by a non-fine, old generation semiconductor process, while still preventing cost increase of the driver.

The drive element mount display in accordance with the present invention can be such that: the display means is a liquid crystal display body; and the driver is a liquid crystal driver driving the liquid crystal display body.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a partially transparent oblique view showing the structure of a liquid crystal driver mount display of embodiment 1 of the present invention.

FIG. 2 is a cross-sectional view of the liquid crystal driver mount display shown in FIG. 1 taken along line A-A′.

FIG. 3 is an oblique view showing a structure for the liquid crystal driver and driver socket provided in the liquid crystal driver mount display shown in FIG. 1.

FIG. 4 is an oblique view showing a structure of the liquid crystal driver and driver socket provided in the liquid crystal driver mount display shown in FIG. 1, especially before the liquid crystal driver is mounted to the driver socket.

FIG. 5 is an oblique view showing another structure for the driver socket provided in the liquid crystal driver mount display of the present invention.

FIG. 6 is an oblique view showing another structure for the driver socket provided in the liquid crystal driver mount display of the present invention.

FIG. 7 is an oblique view showing another structure for the driver socket provided in the liquid crystal driver mount display of the present invention.

FIG. 8 is an oblique view showing another structure for the driver socket provided in the liquid crystal driver mount display of the present invention.

FIG. 9 is an oblique view showing another structure for the driver socket provided in the liquid crystal driver mount display of the present invention.

FIG. 10 is an oblique view showing another structure for the driver socket provided in the liquid crystal driver mount display of the present invention.

FIG. 11 is a cross-sectional view showing another shape for the liquid crystal driver mount display of the present invention.

FIG. 12 is a plan view showing the structure of a conventional TCP.

FIG. 13 is a cross-sectional view of the structure in FIG. 12 taken along line B-B′.

FIG. 14 is a plan view showing a structure of a conventional SOF.

FIG. 15 is a cross-sectional view of the structure in FIG. 14 taken along line B-B′.

FIG. 16 is an illustration of wiring regions of COG-mounted liquid crystal drivers.

### DESCRIPTION OF THE EMBODIMENTS

### Embodiment 1

An embodiment of the liquid crystal driver mount display in accordance with the present invention will be described. The following description contains various limitations that are preferable from a technical point of view to implement the present invention. The present invention is however by no means limited by the embodiments and figures.

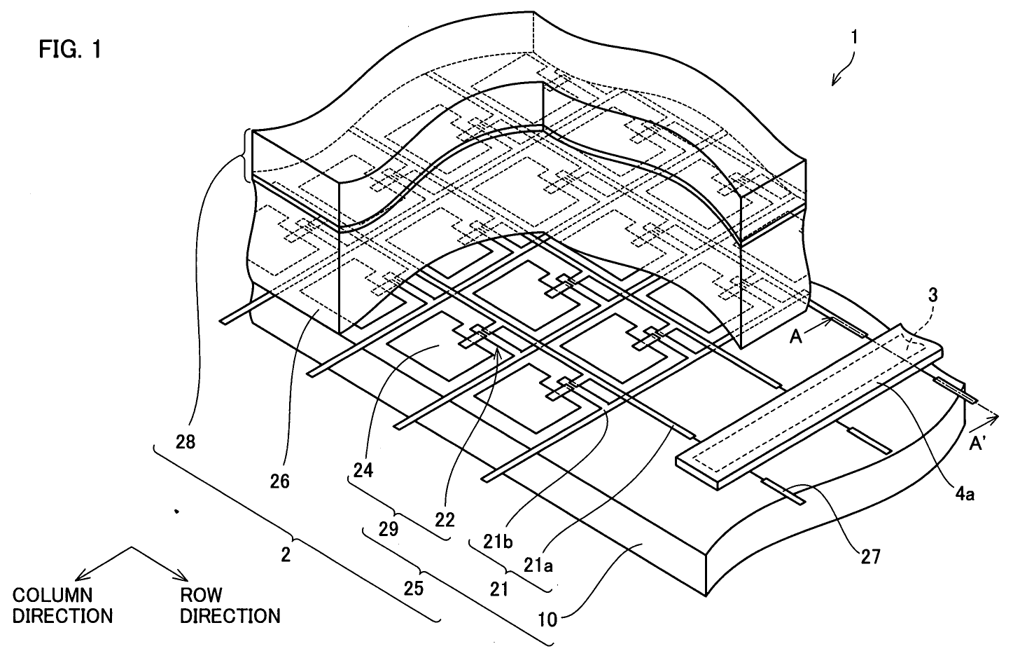

Referring to FIG. 1 to FIG. 4, the following will describe the liquid crystal driver mount display in accordance with the present invention.

FIG. 1 is an oblique view showing the structure of a liquid crystal driver mount display which is an embodiment of the present invention. The liquid crystal driver mount display 1 of the present embodiment includes, as shown in FIG. 1, a liquid crystal display means (display means, liquid crystal display body) 2, a liquid crystal driver (driver) 3, and a driver socket (semiconductor substrate) 4a.

The liquid crystal display means 2 includes an active matrix substrate 25, a liquid crystal layer 26, and an opposite substrate 28 on which an opposite electrode is formed.

The active matrix substrate 25 has a plurality of pixel electrodes formed in an XY matrix on its surface. The active matrix substrate 25 contains, as shown in FIG. 1, a glass substrate (transparent substrate) 20 which carries on it signal wires (data electrode lines 21a and gate electrode lines 21b) 21, switching thin film transistors (“TFTs”) 22, pixel electrodes 24, etc. Each pixel 29 is made of a TFT 22, a pixel electrode 24, etc. The pixels 29 are arranged in an XY matrix (two-dimensional matrix). The gate electrode and data electrode of a TFT 22 are connected respectively to a gate electrode line 21b and a data electrode line 21a.

The gate electrode lines 21b and data electrode lines 21a extend along the row and column directions respectively on the active matrix substrate 25. The lines 21b and 21a are connected at an edge of the glass substrate 10 to the liquid crystal driver 3 via the driver socket 4a. The driver 3 is fed with display data and other control signals from signal lines 27 on the glass substrate via the driver socket 4a. For convenience in description, FIG. 1 shows only the liquid crystal driver 3 and the driver socket 4a for the data electrode lines 21a.

The driver socket 4a broadens the output pitch of the liquid crystal driver 3 to match the pixel pitch. The structure will be described later in more detail. That enables the data electrode lines 21a to the pixel to connect to the liquid crystal driver 3 without changing their pitches. This eliminates the need to provide an area on the glass substrate where the data electrode lines 21a are collected. The frame area can be reduced for that area.

In the present embodiment, the active matrix substrate 25 contains the glass substrate 10. This is by no means limiting the present invention. Conventional, publicly known substrates may be use so long as they are transparent.

The present embodiment deals with the liquid crystal driver for the data electrode lines. This is by no means limiting the present invention. The invention may be applied to the liquid crystal driver for the gate electrode lines.

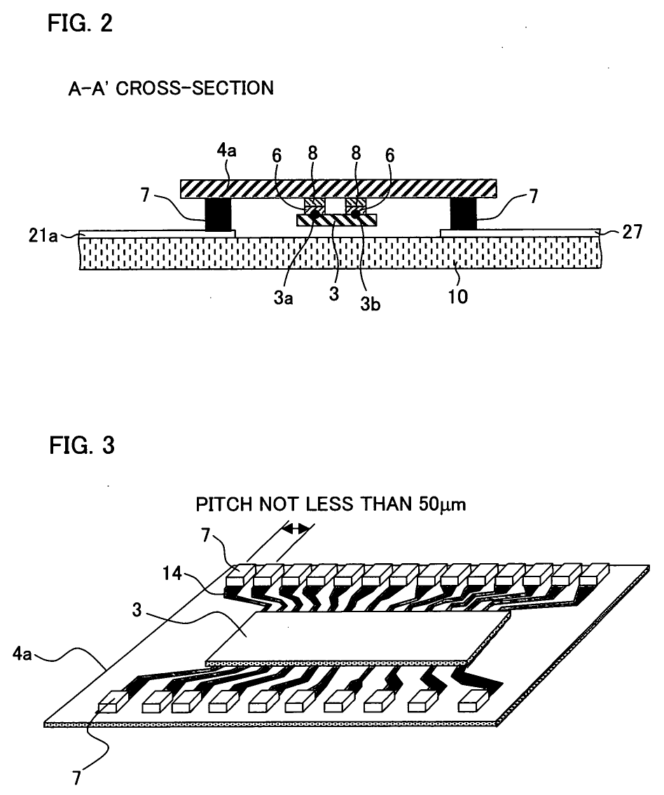

Next, the structure of the liquid crystal driver 3 and the driver socket 4a of the liquid crystal driver mount display 1 will be described specifically in reference to FIG. 2 to FIG. 4.

FIG. 2 is a cross-sectional view of the liquid crystal driver mount display 1 shown in FIG. 1 taken along line A-A′. The liquid crystal driver 3 and the driver socket 4a are mounted on the glass substrate 10 of the liquid crystal display means 2 as shown in FIG. 2.

The liquid crystal driver 3 is provided to drive the liquid crystal display means 2 shown in FIG. 1. To this end, a plurality of liquid crystal drive circuits (ICs; not shown) are provided. Each liquid crystal drive circuit has, as shown in FIG. 2, drive signal output terminals (group of input/output terminals) 3a and signal input terminals (group of input/output terminals) 3b. Drive signals are output via the terminals 3a. Control signals (for example, image data signals) are fed to the liquid crystal driver 3 via the terminals 3b. The liquid crystal driver 3 has first bumps 6 on the drive signal output terminals 3a and the signal input terminals 3b.

The driver socket 4a, on one of its surfaces, is electrically connected to the liquid crystal driver 3, the data electrode lines 21a, and the signal lines 27 on the glass substrate. Specifically, the driver socket 4a, on one of its surface, has second bumps 7 and third bumps 8. As shown in FIG. 2, the data electrode lines 21a, the signal lines 27 on the glass substrate, and the driver socket 4a are electrically connected together by the second bumps 7. The liquid crystal driver 3 and the driver socket 4a are electrically connected by attaching the first bumps 6 to the third bumps 8. The driver socket 4a can be made of a semiconductor material; silicon is a preferred example. The height of the second bumps 7 is preferably greater than the sum of the thickness of the driver 3, the height of the first bumps 6, and the height of the third bumps 8. The size of the driver socket 4a is not limited in any particular manner. It measures, for example, 2 mm×20 mm and is 400 μm thick. The height of the second bumps 7, the thickness of the driver 3, the height of the first bumps 6, and the height of the third bumps 8 are not limited in any particular manner. It is preferable if, for example, the second bumps 7 are 15 μm high, the driver 3 is 5 μm thick, and the first and third bumps 6, 8 have a combined height of 5 μm. The thickness of the driver 3 is preferably tailored by polishing.

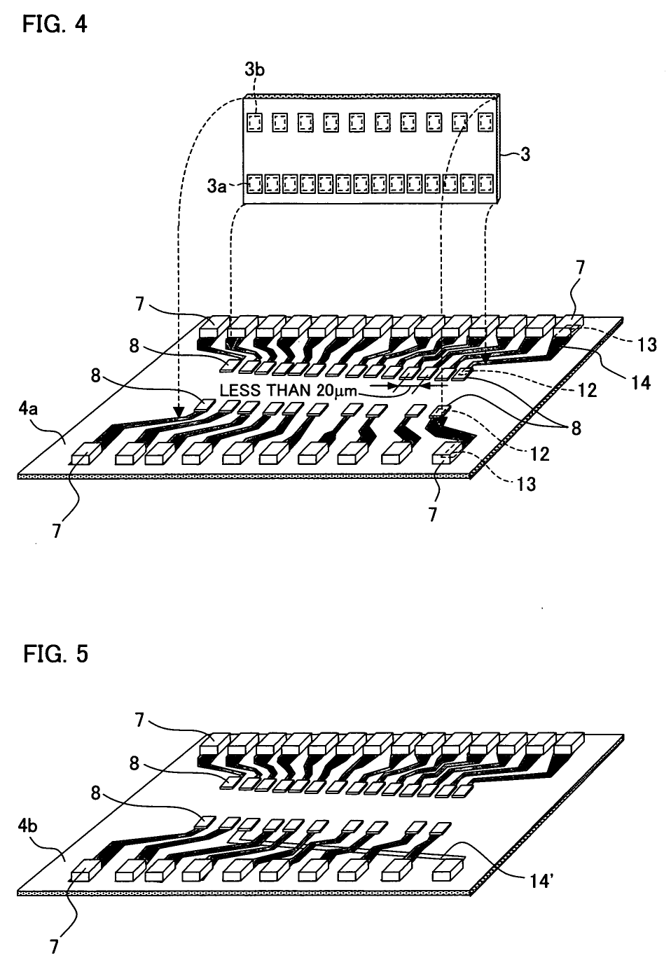

The structure of the driver socket 4a will be described in more detail in reference to FIGS. 3, 4.

FIG. 3 is an oblique view showing the structure of the liquid crystal driver 3 and the driver socket 4a. FIG. 4 is an oblique view showing the structure of the driver socket 4a before the liquid crystal driver 3 is mounted. Note that FIG. 4 is a partially transparent view.

The driver socket 4a has, as shown in FIG. 4, is provided with liquid crystal driver connection terminals (group of driver-end connection terminals) 12, display means-end connection terminals (group of display means-end connection terminals) 13, and metal wires on the socket (wires, metal wires) 14. The terminals 12 connect to the drive signal output terminals 3a and the signal input terminals 3b of the liquid crystal driver 3. The terminals 13 connect to the terminals of the data electrode lines 21a and those of the signal lines 27 on the glass substrate. The wires 14 connect the liquid crystal driver connection terminals 12 to the display means-end connection terminals 13. Specifically, as shown in FIG. 4, the driver socket 4a has the liquid crystal driver connection terminals 12 in its mid-portion and the display means-end connection terminals 13 along its periphery. The liquid crystal driver connection terminals 12 has the third bumps 8 on them. The display means-end connection terminals 13 has the second bumps 7 on them. The third bumps 8 are arranged to match the first bumps 6 on the drive signal output terminals 3a and the signal input terminals 3b on the liquid crystal driver 3 as shown in FIG. 4. The matching enables the configuration shown in FIG. 3.

The third bumps 8 on the driver socket 4a have the same pitches as the first bumps 6 on the drive signal output terminals 3a and the signal input terminals 3b on the liquid crystal driver 3. As already mentioned, the liquid crystal driver 3 has a large number of outputs; the fine pitch is achieved with the first bumps 6.

In contrast, the pitches of the second bumps 7 on the driver socket 4a are wider than those of the third bumps 8. In other words, on the driver socket 4a, the connection terminals for the data electrode lines 21a have wider pitches than the connection terminals for the liquid crystal driver 3.

As explained above, in the configuration of the liquid crystal driver mount display 1 of the present embodiment, on the driver socket 4a, the connection terminals for the liquid crystal driver 3 are formed to match the pitches of the terminals of the liquid crystal driver 3. Also, on the driver socket 4a, the connection terminals for the data electrode lines 21a are formed with wider pitches than the connection terminals for the liquid crystal driver 3. Therefore, the liquid crystal driver 3 has a large number of outputs and the liquid crystal driver 3 has fine-pitch terminals; there is however no need to form the data electrode lines 21a with the same fine pitches as the numerous outputs. The pitch differences between the pixels and the liquid crystal driver (driver socket) are reduced. The area of the glass substrate in which to collect signal wires is reduced. The inclusion of the driver socket 4a in this manner limits increases of the wiring regions (frame area) of the glass substrate 10 where the group of input/output terminals of the driver are connected to the terminals of the signal wires 21 of the liquid crystal display means 2 even in COG mounting as in the present embodiment where the liquid crystal driver 3 is mounted onto the frame of the glass substrate 10 of the liquid crystal display means 2. Thus, the liquid crystal driver 3 with numerous outputs of fine pitches can be mounted onto the glass substrate 10 without adding to the frame area.

In addition, the inclusion of the driver socket 4a allows the pitches of the terminals of the liquid crystal driver 3 to be reduced without considering the terminal pitch of the data electrode lines 21a so long as other conditions permit. This allows reductions of the chip size of the liquid crystal driver 3, hence reductions of its cost.

Filling material may be provided in the area where the glass substrate 10 faces the driver socket 4a and its neighborhood to protect the connecting section from the environment.

In the present embodiment, the liquid crystal driver 3 is located between the driver socket 4a and the glass substrate 10 as shown in FIG. 2. This is by no means limiting the present invention. An alternative structure is shown in FIG. 11. In the structure shown in FIG. 11, the driver socket 4a is provided between the liquid crystal driver 3 and the glass substrate 10. The driver socket 4a has through electrodes 35. The liquid crystal driver 3 connects to the through the data electrode lines 21a via the electrodes 35 and the second bumps 7.

The present embodiment has so far described the structure in which a liquid crystal driver driving the liquid crystal display means is mounted. This is by no means limiting the present invention. The invention is equally applicable to structures in which a driver is mounted in the EL (electroluminescence) display body or other various mobile electronic devices.

The drive element mount display of the present invention can be described as being characterized by the following features.

The drive element mount display is characterized in that it uses, in the mounting of a driver to a display panel, a first group of connection terminals, a second group of connection terminals having connection terminal pitches not narrower than the minimum connection terminal pitch of the first group of connection terminals, and a silicon base material with wires connecting the first group of connection terminals to the second group of connection terminals, wherein the first group of connection terminals is used to connect to the output terminals of a driver, and the second group of connection terminals connect to the wires of a display panel, to bring the driver output pitches close to pixel pitches and reduce the area of the glass substrate in which to collect signal wires. In the best embodiment, the output pitches are made equivalent to the pixel pitches, thereby eliminating the area of the glass substrate in which to collect signal wires.

In this arrangement, it is preferable if the base material is silicon and the wires on the base material are metal wires.

### Embodiment 2

The following will describe another embodiment of the present invention in reference to FIG. 5. The embodiment will focus on differences from embodiment 1. For convenience, members of the present embodiment that have the same arrangement and function as members of embodiment 1, and that are mentioned in that embodiment are indicated by the same reference numerals and description thereof is omitted.

FIG. 5 is an oblique view showing the structure of a driver socket 4b of the liquid crystal driver mount display 1 of the present embodiment. The driver socket 4b of the liquid crystal driver mount display 1 shown in FIG. 5 includes a driver socket 4b in place of the driver socket 4a of the liquid crystal driver mount display 1 described in embodiment 1. The driver socket 4b has metal wires 14′ of a multilayer structure on the socket.

If the wires 14 connecting the display means-end connection terminals 13 to the liquid crystal driver connection terminals 12 is made of a single layer, the display means-end connection terminals 13 and the liquid crystal driver connection terminals 12 must be arranged in the same order. The introduction of a multilayer structure to the wires enables the wires to be crossed as in FIG. 13. That allows the display means-end connection terminals 13 and the liquid crystal driver connection terminals 12 to be arranged in different orders.

For example, the input terminals of the liquid crystal driver in some cases need to be changed according to the type of the liquid crystal display means. When this is the case, the liquid crystal driver itself needs to be altered if the liquid crystal driver is directly attached to the glass substrate of the liquid crystal display means. However, the use of the driver socket 4b, structured as in FIG. 5, allows the wires to be transposed on the driver socket 4b. As mentioned earlier, the driver socket 4b needs no fine processing unlike the liquid crystal driver 3. The socket 4b thus offers a low cost alternative to making changes to the liquid crystal driver.

### Embodiment 3

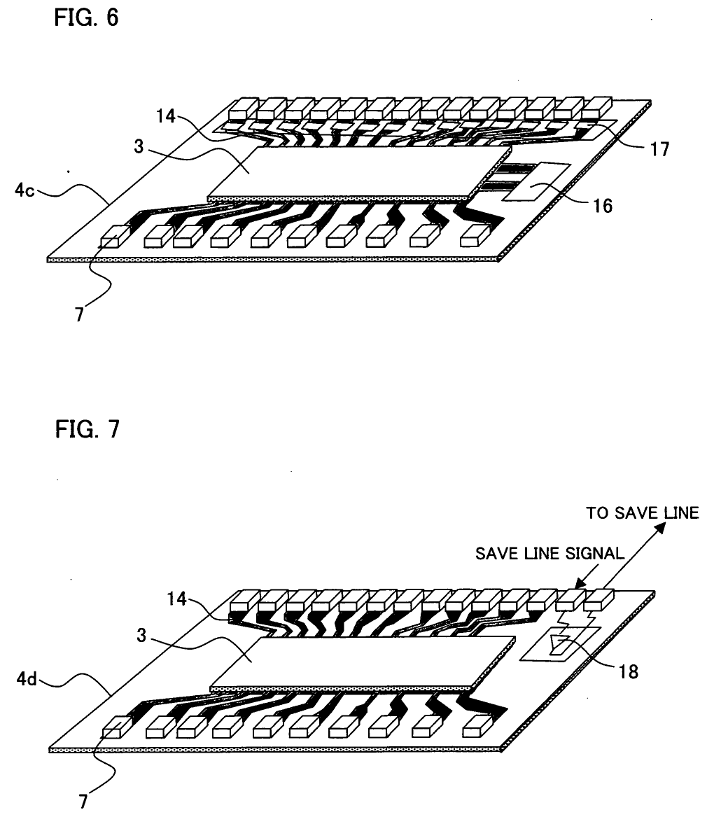

The following will describe another embodiment of the present invention in reference to FIG. 6 to FIG. 9. The embodiment will focus on differences from embodiment 1. For convenience, members of the present embodiment that have the same arrangement and function as members of embodiment 1, and that are mentioned in that embodiment are indicated by the same reference numerals and description thereof is omitted.

The driver socket 4a of the liquid crystal driver mount display 1 of embodiment 1 has, as shown in FIG. 4, the liquid crystal driver connection terminals 12, the display means-end connection terminals 13, and the metal wires 14 on the socket connecting the liquid crystal driver connection terminals 12 to the display means-end connection terminals 13. In contrast, the liquid crystal driver mount display 1 of the present embodiment shown in FIG. 6 to FIG. 9 includes another circuit element on the driver socket. Each driver socket will be described below.

FIG. 6 is an oblique view illustrating the structure of the driver socket 4c of the liquid crystal driver mount display 1. The liquid crystal driver mount display 1 includes a power supply circuit (power supply element) 16 and output drive buffers (output buffer elements) 17, as well as the liquid crystal driver connection terminals 12, the display means-end connection terminals 13, and the metal wires on the socket.

The liquid crystal driver 3 and the driver socket 4c are fabricated by different processes. It is therefore possible, for example, to fabricate the driver socket 4c by a process with which the power supply circuit 16 is readily fabricated so that the power supply circuit 16 on the driver socket 4c can provide a voltage supply to the liquid crystal driver 3.

The driving capability of a driver chip needs to be sufficient to drive the load determined by the size of the mounted liquid crystal display means and other factors. If the driver chip is designed with excess driving capability, the liquid crystal driver becomes unnecessarily large in size. The provision of the output drive buffers 17 to the driver socket 4c as shown in FIG. 6 allows the liquid crystal driver 3 to have a low driving capability. By changing the size of the output drive buffers 17 in accordance with the liquid crystal display means, the same driver 3 can operate with various liquid crystal display means and be kept inexpensive.

The output drive buffers 17, if mounted to the driver socket 4c as in FIG. 6, are provided in numbers corresponding to the number of outputs. The output drive buffers 17 may be mounted to the driver socket 4c so that they correspond to all the outputs or only some of the outputs. Alternatively, the OP amplifiers in the output section of the liquid crystal driver 3 can be provided on the driver socket 4c so that all the output circuitry for liquid crystal drive voltages, including the output drive buffers 17 corresponding to all the outputs, can be manufactured on the driver socket 4c. Thus, the OP amplifiers and other analog circuits can be all disposed on the driver socket 4c, leaving only logic circuits in the liquid crystal driver 3. This allows large reductions in the chip area of the liquid crystal driver 3. The structure increases cost for the driver socket 4c. However, the increased cost does not eat up the cost reduction for the liquid crystal driver 3 if the driver socket 4c is fabricated by a relatively inexpensive process. The overall cost is thus reduced.

FIG. 6 depicts the driver socket 4c that has the output drive buffers 17. The driver socket may include input buffers. Signal inputs to the liquid crystal driver are often produced by RSDS, LVDS, or other display interface technology based on differential signals. The technology requires that a standard compliant receiver be built into the liquid crystal driver. The liquid crystal driver can readily operate with interfaces of different standards if the input buffers and receivers are provided on a semiconductor substrate. This reduces the cost of the liquid crystal driver.

FIG. 7 is an oblique view illustrating another structure for the driver socket. The driver socket 4d shown in FIG. 7 includes redundant buffers (redundant buffer elements) 18, as well as the liquid crystal driver connection terminals 12, the display means-end connection terminals 13, and the metal wires on the socket.

If a signal wire 21 connecting to pixels 29 in the liquid crystal display means 2 is cut off in the middle, the cut-off line does not properly turn on. To prevent this from happening, a solution is known which saves by feeding drive signals from the other end of the cut-off line. The solution adds to the load due to the connection of signal lines and other factors, requiring drive buffers with larger-than-usual driving capability. The mounting of the large redundant buffers to the liquid crystal driver 3 which is fabricated by a fine process is costly. Accordingly, the redundant buffers 18 are mounted to the driver socket 4d as shown in FIG. 7. That limits cost increases for the driver socket 4d to a minimum level and at the same time prevents cost increases for the liquid crystal driver 3.

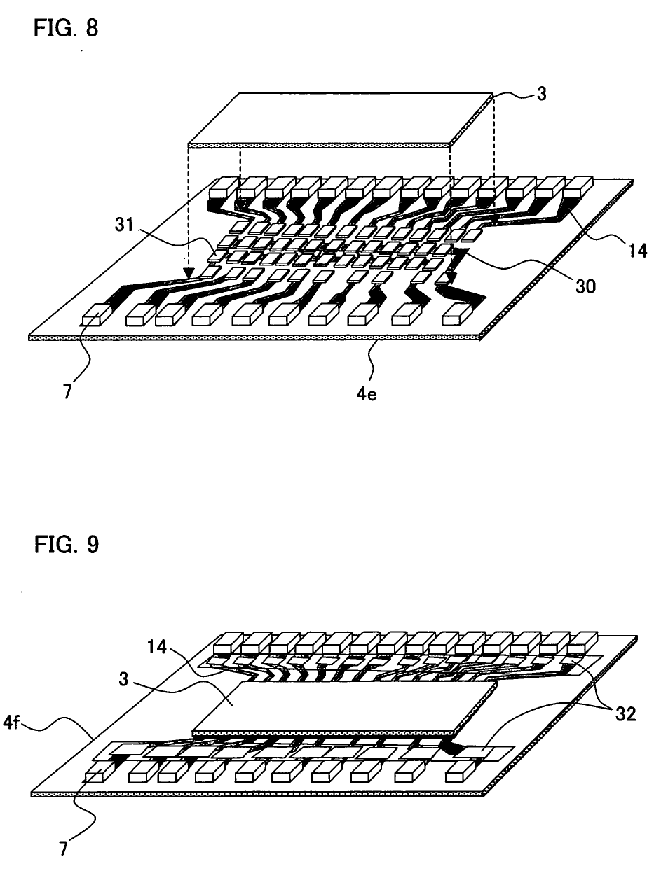

FIG. 8 is an oblique view illustrating another structure for the driver socket. The driver socket 4e shown in FIG. 8 includes a common power supply wire 30 and a common GND wire (common ground wire) 31, as well as the liquid crystal driver connection terminals 12, the display means-end connection terminals 13, and the metal wires on the socket.

The liquid crystal driver 3 includes many output circuits and analog circuitry. If power supply impedances differ between outputs, output voltages also differ (output deviations occur). To reduce the differences, the liquid crystal driver typically needs to adopt multilayer wires to provide wide power supply wires. However, the provision of power supply wires adds another wire layer, which could lead to increased cost. Accordingly, the present embodiment provides the driver socket 4e with common wires (common power supply wire 30 and common GND wire 31) and pads and electrodes which connect the outputs of the liquid crystal driver 3 to the common wires of the driver socket 4e. The configuration allows omission of power supply wires from the liquid crystal driver 3 and reduces power supply impedance differences between the outputs of the liquid crystal driver 3. The output deviations of the liquid crystal driver 3 decrease and display quality improves.

FIG. 9 is an oblique view illustrating another structure for the driver socket. The driver socket 4f shown in FIG. 9 includes a protective element 32, as well as the liquid crystal driver connection terminals 12, the display means-end connection terminals 13, and the metal wires on the socket.

The protective element 32 provides protection from electrostatic discharge (ESD). Electrostatic discharge is thought to have several modes. In one mode, a machine or a worker at an assembly line could charge and later discharge to an integrated circuit. In another mode, a package for an integrated circuit could charge and later discharge to the outside. In any of the modes, the electrostatic discharge could be as high as thousands of volts and destroy integrated circuits. Especially, charge in the former mode and accompanying ESD-caused destruction is likely in a step of mounting a driver socket together with a liquid crystal driver onto a liquid crystal panel. The protective element 32 is included to protect the liquid crystal driver from this kind of electrostatic discharge.

To prevent ESD-caused destruction, the protective element 32 needs to have high voltage tolerance. This is an obstacle in reducing the size of the protective element 32 even when the internal circuitry of the protective element 32 is highly integrated. Here, the protective element 32 is mounted to the driver socket 4f, not to the liquid crystal driver 3. The liquid crystal driver 3 is manufactured by a fine process; without the protective element 32, the liquid crystal driver 3 can be highly integrated, allowing reductions in chip size and cost. In contrast, the driver socket 1 can be manufactured without using fine process like the liquid crystal driver 3; mounting the protective element 32 to the driver socket 1 is less costly than mounting the protective element to the liquid crystal driver.

The drive element mount display of the present invention can be described as being characterized by the inclusion of an element on the driver socket using an integrated circuit process.

The present embodiment has so far described the structures which include output drive buffers and a power supply circuit, input buffers, a power supply circuit, redundant buffers, a common power supply wire, a common GND wire, or a protective element. This is by no means limiting the present invention.

### Embodiment 4

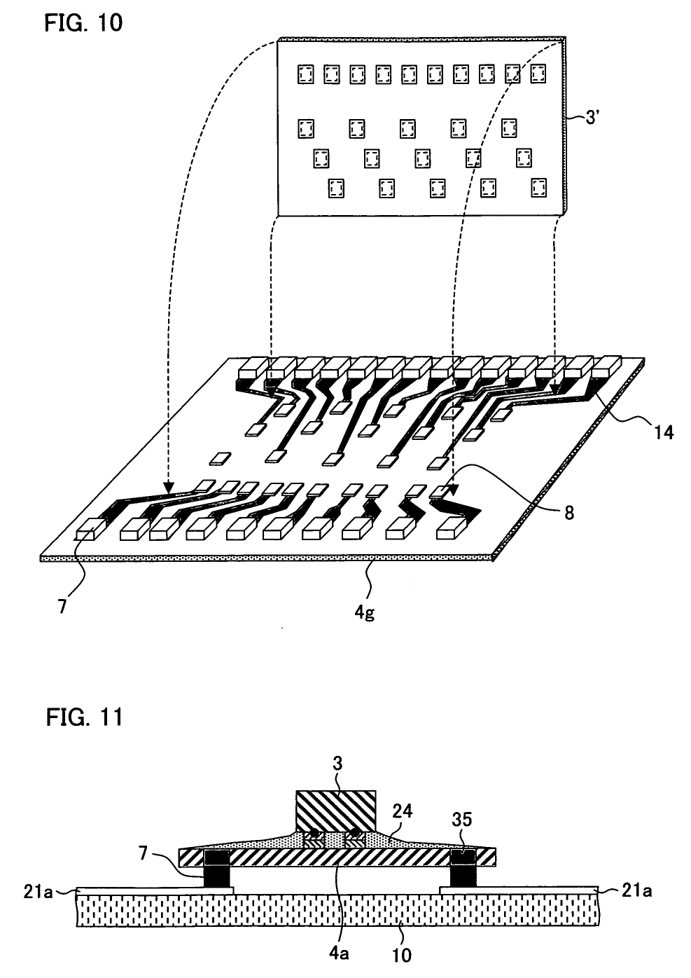

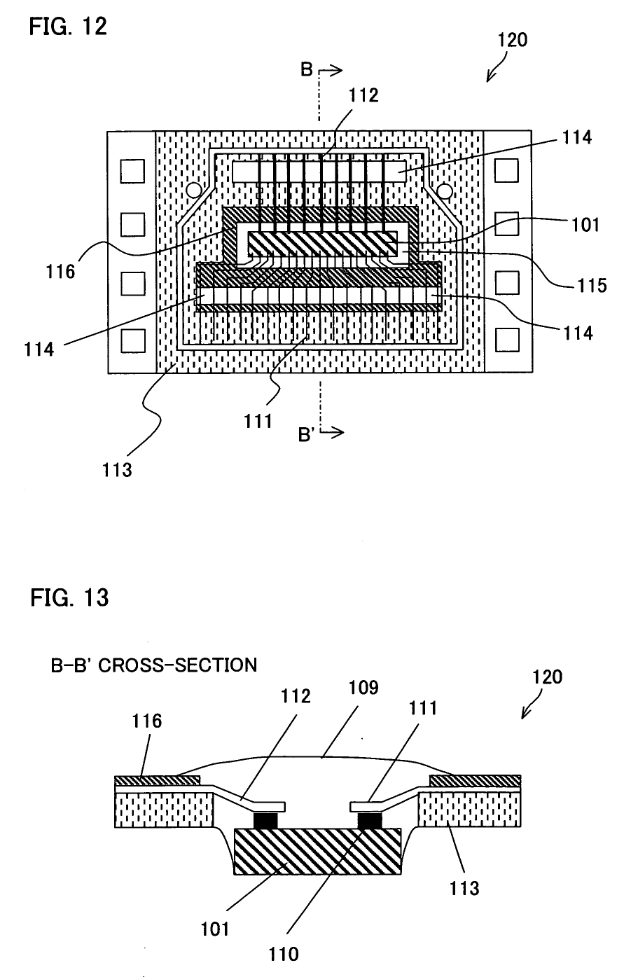

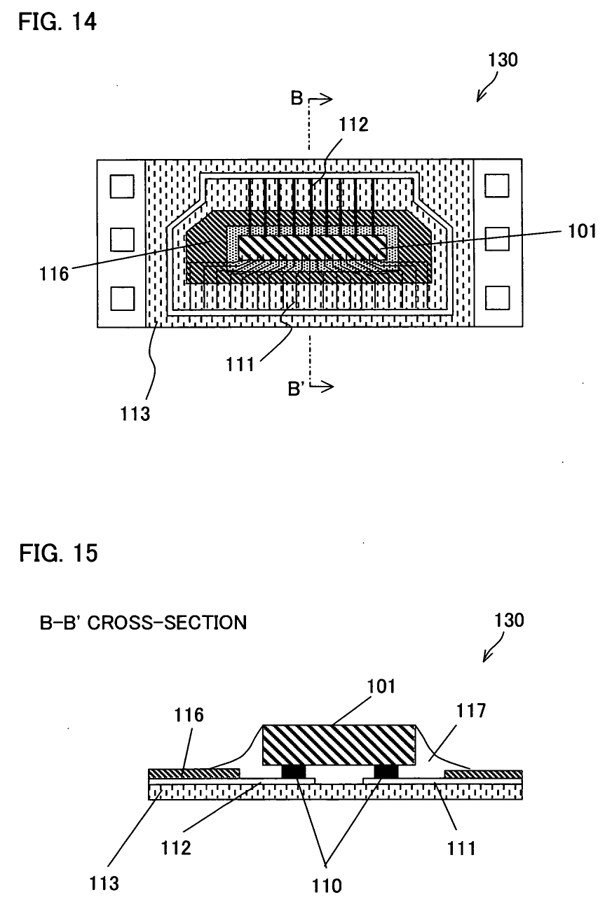

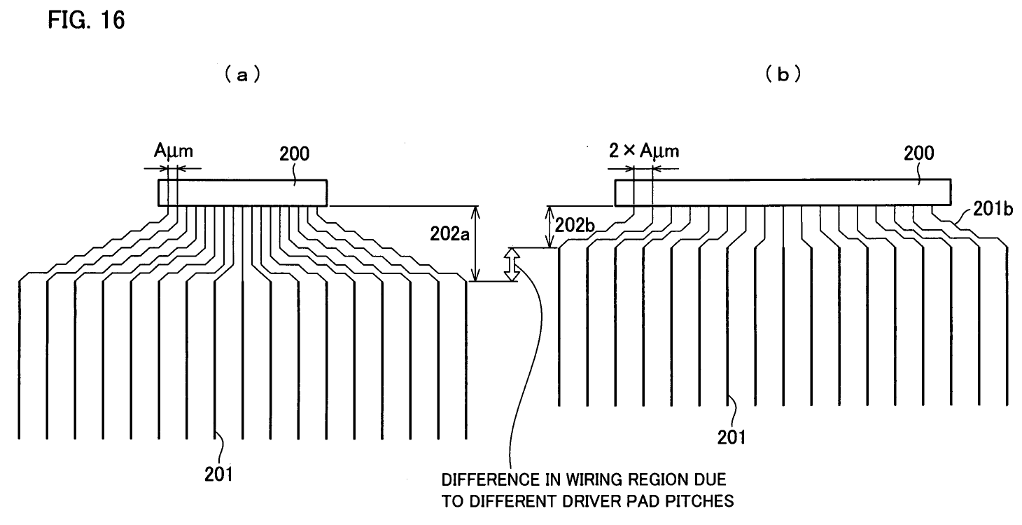

The following will describe another embodiment of the present invention in reference to FIG. 10. The embodiment will focus on differences form embodiment 1. For convenience, members of the present embodiment that have the same arrangement and function as members of embodiment 1, and that are mentioned in that embodiment are indicated by the same reference numerals and description thereof is omitted.

The liquid crystal driver 3 of the liquid crystal driver mount display 1 of embodiment 1 has, as shown in FIG. 4, the terminal pads of the liquid crystal driver 3 being lined up along two opposite ends of the liquid crystal driver 3. Therefore, the liquid crystal driver connection terminals 12 of the driver socket 4a are also lined up along two opposite ends of the driver socket 4a as shown in FIG. 4 so that the terminals 12 can match the terminal pads of the liquid crystal driver 3. In contrast, the liquid crystal driver mount display 1 of the present embodiment includes a liquid crystal driver 3′ with its terminal pads provided all over the liquid crystal driver surface and a driver socket 4g with its liquid crystal driver connection terminals and third bumps 8 provided at positions corresponding to the terminal pads.

The structure eases restrictions in positioning the output circuit (not shown) of the liquid crystal driver 3′. The liquid crystal driver 3′ as a result resembles a square, rather than a rectangle which is the case in FIG. 4.

Integrated circuits, including liquid crystal drivers, are fabricated in multiple numbers on a circular wafer. To obtain more chips from a single wafer, square chips have an advantage. The structure of the liquid crystal driver mount display 1 of the present embodiment allows the liquid crystal driver 3′ to assume a squarish shape. The manufacturing cost of the liquid crystal driver 3′ is reduced.

Alternatively, the squarish shape of the liquid crystal driver 3′ can be achieved by building the metal wires on the driver socket 4g in a multilayer structure as in embodiment 2.

The present invention is not limited to the description of the embodiments above, but may be altered by a skilled person within the scope of the claims. An embodiment based on a proper combination of technical means disclosed in different embodiments is encompassed in the technical scope of the present invention.

Even if a driver with a large number of outputs is mounted to the transparent substrate of display means, the drive element mount display of the present invention does not increase the wiring region of the transparent substrate where the driver is connected to the display means.

Therefore, the invention is applicable to drive element mount displays in which a liquid crystal driver adapted to drive a liquid crystal display is mounted, EL (electroluminescence) display bodies, various mobile electronic devices, etc.

The invention being thus described, it will be obvious that the same way may be varied in many ways. Such variations are not to be regarded as a departure from the spirit and scope of the invention, and all such modifications as would be obvious to one skilled in the art are intended to be included within the scope of the claims.

1. A drive element mount display, comprising:
display means having signal wires and a transparent substrate; and
a drive element applying voltages to the signal wires to drive the display means,
wherein:
the drive element includes: a driver with an integrated circuit and a group of input/output terminals; and a semiconductor substrate, the substrate including: a group of driver-end connection terminals adapted to connect to the group of input/output terminals; a group of display means-end connection terminals adapted to connect to a group of terminals of the signal wires; and wires connecting the group of driver-end connection terminals to the group of display means-end connection terminals;
the group of driver-end connection terminals is adapted to have pitches which match pitches of the group of input/output terminals; and
the group of display means-end connection terminals has pitches not narrower than a minimum pitch of the group of driver-end connection terminals.

2. The drive element mount display of claim 1, wherein the drive element is disposed on the transparent substrate of the display means.

3. The drive element mount display of claim 1, wherein the group of display means-end connection terminals, the group of driver-end connection terminals, and the wires are disposed on one surface of the semiconductor substrate.

4. The drive element mount display of any claim 1, wherein the semiconductor substrate is a silicon substrate.

5. The drive element mount display of claim 1, wherein the wires disposed on the semiconductor substrate are multilayer wires.

6. The drive element mount display of any claim 1, wherein the semiconductor substrate has circuit elements.

7. The drive element mount display of claim 1, wherein the semiconductor substrate has output buffer elements.

8. The drive element mount display of claim 1, wherein the semiconductor substrate has input buffer elements.

9. The drive element mount display of claim 1, wherein the semiconductor substrate has a power supply element.

10. The drive element mount display of claim 1, wherein the semiconductor substrate has a protective element for protecting the driver from electrostatic discharge.

11. The drive element mount display of claim 1, wherein the semiconductor substrate has redundant buffers for, when a signal wire cuts off and is no longer capable of conveying a drive signal to a pixel of the display means, conveying the drive signal to the pixel.

12. The drive element mount display of claim 1, wherein the wires are metal wires.

13. The drive element mount display of claim 1, wherein:
the display means is a liquid crystal display body; and
the driver is a liquid crystal driver driving the liquid crystal display body.
